(19) United States
(12) Patent Application Publication
(10) Pub. No.: US 2022/0198481 A1
(43) Pub. Date: Jun. 23, 2022

(54) SYSTEM AND METHOD FOR SECURING AUTOMATED TRADE TRANSACTION

(71) Applicant: Honda Motor Co., Ltd., Tokyo (JP)

(72) Inventor: Christopher A. FLOERSCH, Chino Hills, CA (US)

(21) Appl. No.: 17/692,450

(22) Filed: Mar. 11, 2022

Related U.S. Application Data
(63) Continuation of application No. 17/010,222, filed on Sep. 2, 2020.
(60) Provisional application No. 62/952,726, filed on Dec. 23, 2019.

(51) Int. Cl. G06Q 30/02; G06Q 40/04; H04L 9/40; G06Q 50/26; G06F 16/23; G06Q 50/28

(52) U.S. Cl. CPC G06Q 30/0201; G06Q 40/04; G06Q 50/28; G06Q 50/26; G06F 16/2379; H04L 63/0428

(57) ABSTRACT

A system and method for providing an automated trade transaction using blockchain technology that include electronically receiving transaction data associated with a plurality of supply chain transactions. The system and method also include electronically aggregating the transaction data associated with the plurality of supply chain transactions received during a predetermined period of time into at least one transactional data package and electronically providing and assigning secure encrypted credentials to the supply chain stakeholder and at least one of: an additional supply chain stakeholder and a regulatory agency to securely access a blockchain infrastructure. The system and method further include electronically passing the at least one transactional data package through the blockchain infrastructure to complete a secure communication of the transaction data between the supply chain stakeholder and at least one of: the additional supply chain stakeholder and the regulatory agency.

### CROSS-REFERENCE TO RELATED APPLICATION

This disclosure is a continuation of, and claims priority to, U.S. application Ser. No. 17/010,222 filed on Sep. 2, 2020, and now published as US 2021/0192545 which claims priority to U.S. Provisional Application Ser. No. 62/952,726 filed on Dec. 23, 2019, both applications of which are expressly incorporated herein by reference.

### BACKGROUND

Supply chain is a sophisticated ecosystem with many stakeholders and multi-stage transactions that may occur in multiple phases. In many cases product manufacturers, importers, retailers, carriers, and various additional stakeholders that are involved in the import and distribution of products within a global supply chain are accountable to provide transactions to additional stakeholders and/or regulatory agencies during each step in the import/export supply chain process. In particular, product manufactures, shipment carriers, terminal operators, producers, transportation providers, product retailers, and/or additional entities may be required to provide transactions for each product (e.g., shipping container, lot of products) that is exported, imported, and passed through the supply chain process to one or more additional stakeholders and/or regulatory agencies.

Much of this transactional or electronic reference data may include highly sensitive information, including but not limited to, commercial information, financial information, logistical information, regulatory information, ledgers, trade secrets, shipping route information, transactional information, product specific information, model specific information, and the like. The complexity with respect to the numerous stakeholders and multi-stage transactions may result in large challenges in maintaining the flow of supply chain information, data, and documents which may cause issues with respect to supply chain efficiency, visibility, and transparency. For example, the amount of electronic information for large volume shipments may cause a backlog and/or much overhead with respect to providing a high volume of documentation to one or more stakeholders. In addition to being cumbersome for the various stakeholders in the supply chain process, having a high amount of electronic data that may include highly sensitive information may also increase a cost associated with the security and protection of higher amounts of data.

### BRIEF DESCRIPTION

According to one aspect, a computer-implemented method for providing an automated trade transaction using blockchain technology that includes electronically receiving transaction data associated with a plurality of supply chain transactions is provided. The plurality of supply chain transactions are associated with a supply chain stakeholder. The computer-implemented method also includes electronically aggregating the transaction data associated with the plurality of supply chain transactions received during a predetermined period of time into at least one transactional data package. The computer-implemented method additionally includes electronically providing and assigning secure encrypted credentials to the supply chain stakeholder and at least one of: an additional supply chain stakeholder and a regulatory agency to securely access a blockchain infrastructure. The computer-implemented method further includes electronically passing the at least one transactional data package through the blockchain infrastructure to complete a secure communication of the transaction data between the supply chain stakeholder and at least one of: the additional supply chain stakeholder and the regulatory agency.

According to another aspect, a system for providing an automated trade transaction using blockchain technology is provided. This includes a memory storing instructions when executed by a processor cause the processor to electronically receive transaction data associated with a plurality of supply chain transactions. The plurality of supply chain transactions are associated with a supply chain stakeholder. The instructions also cause the processor to electronically aggregate the transaction data associated with the plurality of supply chain transactions received during a predetermined period of time into at least one transactional data package. The instructions additionally cause the processor to electronically provide and assigning secure encrypted credentials to the supply chain stakeholder and at least one of: an additional supply chain stakeholder and a regulatory agency to securely access a blockchain infrastructure. The instructions further cause the processor to electronically pass the at least one transactional data package through the blockchain infrastructure to complete a secure communication of the transaction data between the supply chain stakeholder and at least one of: the additional supply chain stakeholder and the regulatory agency.

According to yet another aspect, a non-transitory computer readable storage medium storing instructions that when executed by a computer, which includes a processor performs a method is provided. The method includes electronically receiving transaction data associated with a plurality of supply chain transactions. The plurality of supply chain transactions are associated with a supply chain stakeholder. The method also includes electronically aggregating the transaction data associated with the plurality of supply chain transactions received during a predetermined period of time into at least one transactional data package. The method additionally includes electronically providing and assigning secure encrypted credentials to the supply chain stakeholder and at least one of: an additional supply chain stakeholder and a regulatory agency to securely access a blockchain infrastructure. The method further includes electronically passing the at least one transactional data package through the blockchain infrastructure to complete a secure communication of the transaction data between the supply chain stakeholder and at least one of: the additional supply chain stakeholder and the regulatory agency.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for providing an automated trade transaction using blockchain technology according to an exemplary embodiment of the present disclosure;

FIG. 2 is a schematic view of a plurality of modules of a secure transaction application that may execute computer-implemented instructions for providing an automated trade transaction using blockchain technology according to an exemplary embodiment of the present disclosure;

FIG. 3 is an illustrative example of the functionality of the secure transaction application according to an exemplary embodiment of the present disclosure;

FIG. 4 is a process flow diagram of a method for aggregating and communicating supply chain transaction data to one or more stakeholders according to an exemplary embodiment of the present disclosure; and

FIG. 5 is a process flow diagram of a method for providing an automated trade transaction using blockchain technology according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

### I. System Overview

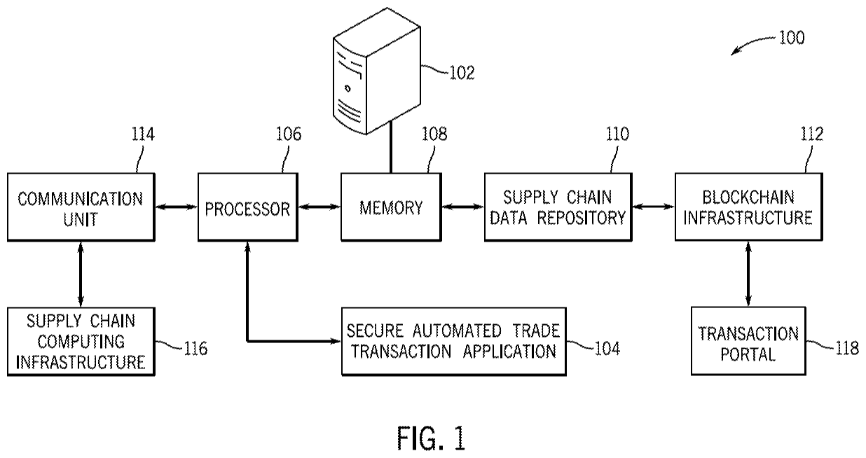

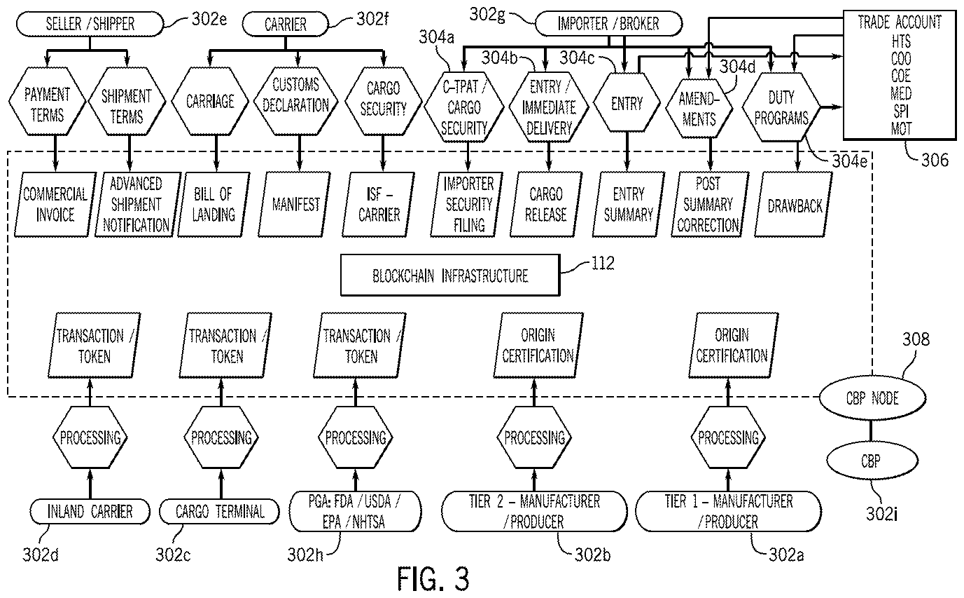

Referring now to the drawings, wherein the showings are for purposes of illustrating one or more exemplary embodiments and not for purposes of limiting the same, FIG. 1 is a schematic view of an exemplary system 100 for providing an automated trade transaction using blockchain technology according to an exemplary embodiment of the present disclosure. The automated trade transaction may be related to a secure transmission and exchange of transactions that may include, but may not be limited to, trade information, customs information, financial information, transactional information, commercial information, logistical information, regulatory information, contractual information, accounting ledger information, customs declaration information, and/or additional types of trade related information between supply chain stakeholders (stakeholders) and/or regulatory agencies (examples represented in FIG. 3, discussed below).

In an exemplary embodiment, the system 100 may include a trade customs logistics server (logistics server) 102 that may be configured to execute a secure automated trade transaction application (secure transaction application) 104. The secure transaction application 104 may be configured to present a human machine interface (HMI) that may include various user interfaces that may be presented to various stakeholders to allow the stakeholders to input and/or receive transactional data or reference information that may be provided to or received from one or more (additional) stakeholders and/or one or more regulatory agencies. The secure transaction application 104 may also be configured to present an HMI to various regulatory agencies to allow the regulatory agencies to input and/or receive transactional data or reference information that may be provided to or received from one or more (additional) stakeholders and/or one or more regulatory agencies.

The stakeholders may include, but may not limited to, original equipment manufacturers (OEM), importers, exporters, brokers, sellers, shippers, carriers, inland carriers, cargo terminal operators, origin/destination agents, customs bonded warehouses, financial intermediaries, ports, shipping lines, insurance companies, participating governmental agencies, tier two manufacturers/producers, tier one manufacturers/producers. Additionally, the regulatory agencies may include, but may not be limited to customs and border related regulatory agencies, trade related regulatory agencies, transportation related regulatory agencies, health related regulatory agencies, product safety related regulatory agencies, food safety related regulatory agencies, public safety related regulatory agencies, and the like. The regulatory agencies may be assocaited with one or more countries, jurisdictions, and the like (e.g., national/federal agency, state/provincial agency, county/city agency). As discussed below, the secure transaction application 104 may be configured to enable the upload of transactions from one or more of the stakeholders and/or regulatory agencies to be communicated to one or more additional stakeholders and/or regulatory agencies that may be involved in a global or regional supply chain.

The secure transaction application 104 may reduce an amount of overhead related to communication of multiple transactions to one or more additional stakeholders and/or regulatory agencies for each supply chain transaction (e.g., multiple documents that may be provided during the import of one or more container/shipments of goods). In particular, the secure transaction application 104 may be configured to enable the upload of transactions for one or more stakeholders for a predetermined period of time. The secure transaction application 104 may be configured to analyze a plurality of transactional data points that each include information that is associated with respective transactions that may be transmitted and exchanged by one or more of the stakeholders. As discussed below, the secure transaction application 104 may be configured to categorize the plurality of transactional data points. The secure transaction application 104 may also be configured to aggregate the transactional data points of one or more particular categories into one or more transactional data packages that may be associated with one or more respective categories and/or one or more particular stakeholders for the predetermined period of time.

In one or more embodiments, one or more transactional data packages that are associated with a particular stakeholder for the predetermined period of time may include information that is captured and/or aggregated from the various transaction data points (e.g., required data that is to be provided to the regulatory agencies) that may be received by one or more additional stakeholders and/or one or more regulatory agencies and viewed in one or more formats. For example, transaction data points that are included within the transactional data package may be extracted and viewed in one or more graphical formats, including, but not limited to, a database format, a spreadsheet format, a custom regulatory agency application program interface (API) format, a third-party supply chain/logistics data management API format, and the like.

As discussed below, the secure transaction application 104 may be configured to communicate one or more transactional data packages to one or more additional stakeholders such as one or more respective regulatory agencies through blockchain technology to mine the respective transactions and verify them for secure transmission and exchange in an encrypted and secure manner using blockchain. Stated differently, each of the one or more transactional data packages may be passed through blockchain technology in a secure manner to be received and reviewed by one or more additional stakeholders.

Accordingly, the functionality of the secure transaction application 104 may allow a bidirectional flow of data in an efficient manner that reduces overhead, documentation/paperwork, duplication of data, and provides a secure and encrypted means to communicate transactional data to one or more stakeholders and required trade transactional data to one or more regulatory agencies. The secure transaction application 104 may be configured to enable one or more stakeholders to upload transactional data points that may be aggregated and be provided in a secure manner to a regulatory agency such as a customs and border protection agency during import and/or export of products. For example, transactional data such as purchase orders, invoices, shipping notices, bills of landing, letters of credits, certificates of origin and/or import/export declarations may be respectively aggregated and uploaded for transmission from an international shipper of goods to be passed through the blockchain technology in a secure manner to be received by one or more regulatory agencies such as a customs and border protection agency of a particular country in which goods are being imported.

The functionality of integrating blockchain within the supply chain may enable advance sharing of commercial and trade data between the stakeholders and/or the regulatory agencies. Additionally, this functionality may allow for greater data cooperation between the stakeholders and/or regulatory agencies which may enable greater supply chain visibility with respect to one or more types of transaction data. With respect to import/export of goods, the utilization of the application 104 may provide benefits to the trade and broker side since workload may be reduced to assemble the required information for declarations with respect to the customs and border regulatory agencies. With respect to the customs side, the application 104 may reduce the need for manual verification of numerous documents and additional resources that may be required to validate data included within numerous declarations.

In one or more embodiments, the secure transaction application 104 may be configured to utilize third-party accounting system tools to collect transactional data and ledger data pertaining to financial, statistical reporting, and payment status that may be associated with one or more stakeholders and/or one or more shipments. In one configuration, the secure transaction application 104 may be configured to follow an accounting cycle with respect to financial transactions between one or more stakeholders and/or associated with one or more shipments as included within transactional data points that are associated with one or more stakeholders and/or with one or more shipments.

The secure transaction application 104 may facilitate the secure distribution of ledgers between stakeholders to ensure that information flow with respect to financial transactions are streamlined and consolidated. This functionality may thereby limit the input of manual data resulting in an elimination of data duplication and manual processing errors which may facilitate timely sharing of supply chain data among the stakeholders while assuring quality and integrity of data. Accordingly, the secure distribution of ledgers between stakeholders may enhance supply chain predictability by improving information flow and may reduce administrative costs. In other words, with respect to accounting cycles, the functionality of the secure transaction application 104 may integrate distributed ledgers with the trade process and may provide enhanced collaboration between various stakeholders and regulatory agencies within the supply chain.

With continued reference to the operating environment of FIG. 1, the logistics server 102 may include a processor 106. The processor 106 may operably control one or more components of the logistics server 102. In an exemplary embodiment, the processor 106 may be configured to execute the secure transaction application 104. The processor 106 may be configured to execute one or more operating systems, OEM system and subsystem executable instructions, and the like. The processor 106 may also include respective internal processing memory, an interface circuit, and bus lines for transferring data, sending commands, and communicating with the plurality of components of the logistics server 102.

In one embodiment, the processor 106 may be operably connected to a memory 108 of the logistics server 102. The memory 108 may be configured to store data files associated with one or more applications, operating systems, OEM systems, OEM system user interfaces, including but not limited to data files of the secure transaction application 104. In one embodiment, the memory 108 may be configured to store a supply chain data repository 110.

In one or more embodiments, the supply chain data repository 110 may be configured as a relational database that may be populated based on data that is received through a communication unit 114 of the logistics server 102. The supply chain data repository 110 may be configured to include records (e.g., data records with data fields) that respectively pertain to one or more stakeholders. In some embodiments, the supply chain data repository 110 may be configured to include records that respectively pertain to one or more categories of data (e.g., accounting data, financial data, transactional data, contractual data, etc.)

As discussed below, the supply chain data repository 110 may be accessed by the secure transaction application 104 to be populated to store the transactional data points that may be associated with one or more respective stakeholders and/or that may be categorized based on one or more categories of data for a predetermined period of time (e.g., 30 days). The supply chain data repository 110 may also be accessed to store real-time supply chain data that is associated with one or more stakeholders and is communicated from a supply chain computing infrastructure 116.

In an exemplary embodiment, the supply chain computing infrastructure 116 may be configured to include one or more externally hosted computing systems that may be owned, operated, and/or hosted by each of the stakeholders. For example, the supply chain computing infrastructure 116 may be configured to include one or more externally hosted computing systems that may be owned, operated, and/or hosted by one or one or more manufacturing facilities, one or more ports of entry, one or more receiving locations, one or more carriers, one or more retailers, and the like that may pertain to the end-to-end supply chain of one or more particular products, one or more particular product models, one or more particular product configurations, and the like.

With continued reference to the logistics server 102, the processor 106 of the logistics server 102 may also be operably connected to the communication unit 114. The communication unit 114 may include one or more network interface cards (not shown) that may be configured to connect to one or more computing systems through an internet cloud (not shown). In some configurations, such computing systems may include, but may not be limited to, computing systems of the OEM, computing systems of one or one or more manufacturing facilities, computing systems of one or more ports of entry, computing systems of one or more receiving locations, computing systems of one or more staging locations, computing systems of one or more retailors, and the like that may pertain to the end-to-end supply chain of one or more particular products.

In one embodiment, at each step of the supply chain process, each shipment may be scanned in for confirmation of the supply chain step. The scanning may be utilized to input transaction data points (e.g., through the scanning of products, shipment lots, containers). Additionally, account data associated with the stakeholder and/or each particular shipment may be inputted as a plurality of transactional data points. The secure transaction application 104 may utilize the communication unit 114 to communicate with the supply chain computing infrastructure 116 that may be provided as a communication interface to the one or more stakeholders to input transaction data points to the secure transaction application 104.

In one embodiment, upon communicating with the supply chain computing infrastructure 116 and receiving transaction data in the form of the plurality of transaction data points, the secure transaction application 104 may utilize the supply chain data repository 110 to store the transactional data points for each stakeholder for a predetermined period of time (e.g., thirty-days). The transactional data points may include pre-stored stakeholder data that may be associated with the specific stakeholder. The stakeholder data may include a stakeholder identification (ID) that may include an identifying name, description, code (e.g., alpha-numeric identification) that may be associated with each stakeholder. The stakeholder data may also include one or more relevant locations of each stakeholder including but not limited to a principal place of business, a manufacturing location, a business office location, a shipping location, etc. The stakeholder data may additionally include a stakeholder type that pertains to a category of each stakeholder (e.g., OEM, carrier, shipper, regulatory agency).

The transactional data points may additionally include various data categories that may include, but may not be limited to, The transactional data points may additionally include various data categories that may include, but may not be limited to, financial transactional data, financial account data, specific data associated with one or more goods/products (e.g., product name, product ID, product model), accounting data that may be associated with one or more specific accounts, contractual data associated with one or more contracts that may pertain to one or more particular stakeholders and/or regulatory agencies, statistical data, payment status data, trade account classifications and data associated with one or more trade accounts that may link trade attributes together, and specific identification data associated with the each supply chain transaction itself (e.g., transaction ID).

In an exemplary embodiment, the system 100 may include a blockchain infrastructure 112. The blockchain infrastructure 112 may be configured to include one or more externally hosted computing systems that may be owned, operated, and/or hosted by one or more blockchain technology providers. In one embodiment, the secure transaction application 104 may be configured to utilize the communication unit 114 to communicate transaction data that may be sent by one or more stakeholders to the blockchain infrastructure 112.

In particular, the secure transaction application 104 may be configured to transfer one or more transactional data packages associated with one or more particular supply chain stakeholders and/or regulatory agencies through the blockchain infrastructure 112 to pass the one or more transactional data packages through blockchain technology. Accordingly, one or more transactional data packages that include an aggregation of transactional data points and may include one or more categories of data that are associated with transactions may be passed through the blockchain infrastructure 112 to complete the transfer of the transactions to one or more stakeholders and/or regulatory agencies through a transaction portal 118. For example, one or more transactional data packages that may be transmitted from a manufacturer may be passed through the blockchain infrastructure 112 to complete the transfer of transactions to a seller, a shipper, and a regulatory trade agency.

In one or more embodiments, the transaction portal 118 may include one or more data link nodes to one or more externally hosted computing systems that may be owned, operated, and/or hosted by one or more stakeholders and/or one or more regulatory agencies to input secure data (e.g., used by a regulatory agency to review transaction data for cargo release, entry, entry summary, duty, and duty payment interfaces). Accordingly, transactional data packages that include transaction data associated with a plurality of supply chain transactions and with one or more of the stakeholders may be communicated from the blockchain infrastructure 112 after being passed through blockchain technology in a secure manner to be received and processed by the one or more additional stakeholders and/or one or more regulatory agencies through the transaction portal 118.

In one configuration, the secure transaction application 104 may be configured to utilize blockchain technology that may be configured as part as a secure blockchain that is accessible to one or more stakeholders and/or regulatory agencies that are provided with a secure encrypted credentials. In one embodiment, the secure encrypted credentials may be provided by the secure transaction application 104 in the form of a private encrypted data keys (private keys) (not shown) that may be assigned to stakeholders and/or regulatory agencies that may communicate transaction data that may be sent to one or more additional stakeholders and/or regulatory agencies. Such credentials may also be provided by the application 104 in the form of private keys that may be assigned to stakeholders and/or regulatory agencies that receive transaction data through the blockchain. Each of the private keys may be encrypted with a numerical encrypted key code or alpha-numerical encrypted key code that may not be publicly accessible. The private keys may be exchanged as ownership credentials to securely access the blockchain infrastructure 112 through the transaction portal 118 to send and/or receive transaction data.

In some configurations, the blockchain may be configured as a consortium blockchain where particular stakeholders and/or regulatory agencies may work together to form an alliance and participate in the management of the blockchain. In particular, stakeholder and/or regulatory agency members of the blockchain consortium may collaborate to determine how the blockchain is implemented and operated. In one or more embodiments, the secure transaction application 104 may enable each of the stakeholders of the blockchain consortium to access the blockchain infrastructure 112 through the transaction portal 118 to send and/or receive transaction data through the blockchain. Each of the stakeholders may be authorized by the application 104 based on known identifies such that only authorized stakeholders and/or regulatory agencies may create, read, and/or update transaction data that is to be aggregated and passed through the blockchain by the application 104.

### II. The Secure Automated Trade Transaction Application and Methods Executed by the Application

The secure transaction application 104 and its components will now be discussed in more detail according to an exemplary embodiment and with continued reference to FIG. 1. In one or more embodiments, the secure transaction application 104 may be stored on the memory 108 of the logistics server 102 and may be executed by the processor 106 of the logistics server 102. In another embodiment, the secure transaction application 104 may be stored on an externally hosted server infrastructure (not shown), one or more computing systems of the blockchain infrastructure 112, and/or one or more computing systems of the transaction portal 118 and may be accessed by the logistics server 102 through the communication unit 114 to be executed by the processor 106 of the logistics server 102. In yet some additional embodiments, the secure transaction application 104 may be stored on the logistics server 102, one or more computing devices of the blockchain infrastructure 112, and/or the portable device and/or computing infrastructure used by one or more respective stakeholders.

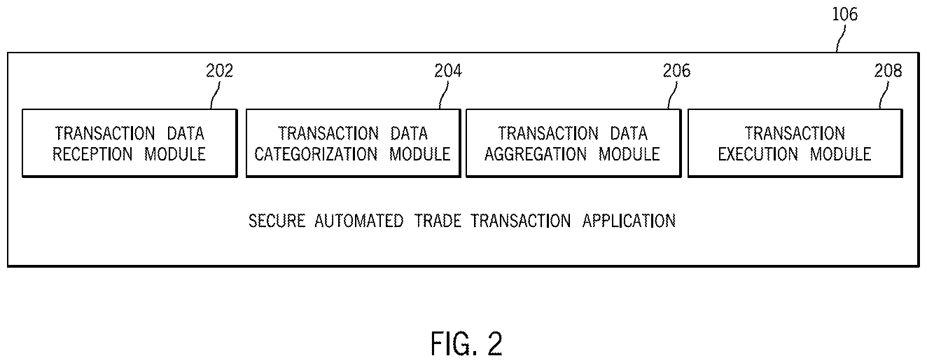

FIG. 2 is a schematic view of a plurality of modules 202-208 of the secure transaction application 104 that may execute computer-implemented instructions for providing an automated trade transaction using blockchain technology according to an exemplary embodiment of the present disclosure. In an exemplary embodiment, the plurality of modules 202-208 may include a transaction data reception module 202, a transaction data categorization module 204, a transaction data aggregation module 206, and a transaction execution module 208. It is appreciated that the secure transaction application 104 may include one or more additional modules and/or sub-modules that are included in addition to or in lieu of the modules 202-208.

In an exemplary embodiment, the transaction data reception module 202 of the secure transaction application 104 may be configured to present one or more human machine interfaces (HMIs) of the secure transaction application 104 through the supply chain computing infrastructure and/or the transaction portal 118 to be presented to one or more stakeholders. As discussed below, the HMIs of the application 104 may allow the supply chain stakeholders to input one or more types of transaction data to be communicated to one or more additional stakeholders. Upon the population of the HMI, the transaction data reception module 202 may be configured to receive the transaction data and store the transaction data as a plurality transaction data points upon the supply chain data repository 110.

The transaction data categorization module 204 of the secure transaction application 104 may be configured to access the supply chain data repository 110 and may analyze the plurality of transaction data points of the one or more types of transaction data that is inputted by one or more stakeholders through the HMIs of the application 104. In one embodiment, the transaction data categorization module 204 may analyze the transaction data points to categorize the transaction data into one or more data categories that may be associated with regulatory information, legal information, contractual information, transactional information, customs information, trade account information, and/or product specific information included within the transaction data. In particular, the transaction data categorization module 204 may analyze the one or more types of transaction data to determine and categorize the type information included within the one or more types of transaction data. Such categories may be appended to the one or more transactional data points that are stored upon the supply chain data repository 110.

The transaction data aggregation module 206 of the secure transaction application 104 may be configured to access the supply chain data repository 110 and may retrieve a plurality of transaction data points that may be associated with one or more sender stakeholders, one or more sender regulatory agencies, one or more recipient stakeholders, and/or one or more recipient regulatory agencies. Additionally or alternatively, the transaction data aggregation module 206 may be configured to retrieve a plurality of transaction data points that may be associated with one or more sender stakeholders, one or more sender regulatory agencies, one or more recipient stakeholders, and/or one or more recipient regulatory agencies and may pertain to one or more particular categories of data included within the plurality of transaction data points as categorized by the transaction data categorization module 204. In one or more embodiments, the transaction data aggregation module 206 may be configured to aggregate the plurality of transaction data points associated with one or more sender stakeholders, one or more sender regulatory agencies, one or more recipient stakeholders, and/or one or more recipient regulatory agencies, and/or that pertain to one or more particular categories of data into one or more transactional data packets (e.g., electronic data packets). The one or more transactional data packets may thereby be communicated to the transaction execution module 208 of the secure transaction application 104.

The transaction execution module 208 may be configured to pass the one or more transactional data packages that include aggregated transaction data points associated with one or more sender stakeholders, one or more sender regulatory agencies, one or more recipient stakeholders, and/or one or more recipient regulatory agencies, and/or that pertain to one or more particular categories through the blockchain. The one or more transactional data packages may be passed through blockchain to be verified through blockchain technologies to complete the secure communication of one or more categories of transaction data to one or more stakeholders and/or one or more regulatory agencies within a supply chain. Accordingly, the secure transaction application 104 may thereby ensure that numerous transactions are cut down to a far less number of transactions and securely communicated through the blockchain to one or more additional stakeholders and/or regulatory agencies through the transaction portal 118.

Accordingly, the secure transaction application 104 may apply the use of the aggregation of transaction data associated with a plurality of supply chain transactions and the use of blockchain to supply chain, logistics, and trade related transactions to provide a framework for achieving a more time efficient, cost efficient, and work flow efficient information flow between one or more stakeholders and/or one or more regulatory agencies involved within the supply chain. For example, the secure transaction application 104 may apply the use of the blockchain to supply chain, logistics, and trade related transactions to provide a framework for achieving a more time efficient, cost efficient, and work flow efficient information flow cooperation between financial intermediaries, suppliers, importers, brokers, accredited entities, regulatory authorities, government agencies, and the like. With respect to a global supply chain, the functionality of the application 104 may enable an entry process to be more integrated with information flows of international supply chains by improving efficiency in the global supply chain, facilitating data sharing and data exchange among various stakeholders and/or regulatory agencies. The functionality of the application 104 may also enhance compliance with international, national, and regional trade laws to thereby facilitate legitimate cross-border commerce.

In one embodiment, the secure transaction application 104 may be configured to be applied with respect to an accounting cycle that may be specifically applied to trade transactions. In particular, the modules 202-208 may be configured to be used with accounting tools to complete trade transactions and allow data exchange and communication over one or more distributed ledgers using blockchain. In such configurations, transactions may be configured as commercial invoice transactions and may be categorized with respect to trade attributes. Such transactions may also be assigned to one or more stakeholders and/or one or more particular accounts. In one or more embodiments, transaction data points associated with the commercial invoice transactions may be aggregated into transactional data packages and communicated through the blockchain to be accessed by one or more particular stakeholders. Information included within the transactional data packages may be presented to one or more or more particular stakeholders through HMIs of the secure transaction application.

In one configuration, the secure transaction application 104 may thereby enable one or more stakeholders to utilize the functionality of the application 104 to follow an accounting cycle. In particular, transactional data points and/or transactional data packages may be reviewed by one or more stakeholders and may be associated to a specific ‘trade account’ (represented in FIG. 3). In some configurations, the supply chain data repository 110 may be configured to include records associated with particular trade accounts that may be configured to be populated with entry journal entry information, post journal entry information, periodic adjustment information, and book closing information that may be associated with one or more transactions pertaining to particular trade accounts. Accordingly, the secure transaction application 104 may enable such transactions to be categorized, aggregated, and communicated to one or more stakeholders using blockchain.

In some configurations, the secure transaction application 104 may be configured to access the supply chain data repository 110 and may be configured to communicate the account related transactional data packages that may include information from the records associated with particular accounts stored upon the supply chain data repository 110 through the blockchain. In one configuration, the secure transaction application 104 may be configured to analyze the transactional data packages and may communicate the account related transactional data packages through the blockchain in one or more specific formats.

As an illustrative example, the secure transaction application 104 may be configured to communicate data included within transactional data packages in a statement format that may include an overall financial picture and status based on the information included within the records associated with particular accounts stored upon the supply chain data repository 110. In one configuration, a statement may be communicated though the blockchain to a specific regulator agency. The statement may include entry journal entry information, post journal entry information, periodic adjustment information, and book closing information. Accordingly, the secure transaction application 104 may provide a unified view of data model that allows data exchange and communication over one or more distributed ledgers. The unified view may provide a consistent perspective with respect to different views of supply chain models (e.g., trade, transportation, regulatory declaration, and finance) and may thereby assist in the integration of distributed ledgers with third-party systems (e.g., enterprise resource planning systems) that may be maintained and/or administered by each of the one or more stakeholders and/or regulatory agencies.

In one embodiments, the secure transaction application 104 may enable transactions to be communicated to and from one or more stakeholders and/or regulatory agencies such that such transactions may be adjusted through one or more HMIs of the application 104 and/or customized user interfaces that are utilized by third-party applications used by one or more stakeholders and/or regulatory agencies. In particular, one or more stakeholders and/or regulatory agencies may access a transactional data package that includes aggregated transactional data points. The application 104 may be configured to present the transactional data points as individually presented through an HMI of the application 104. The application 104 may also allow the stakeholders and/or regulatory agencies to adjust information included within the transactional data points. For example, upon communicating a transactional data package that includes a general ledger of accounts, one or more stakeholders may adjust transaction data (e.g., quantity, value, duties). Such adjusted transaction data may be included within adjusted transaction data points that may be aggregated into a (adjusted) transactional data package to be communicated to one or more additional stakeholders and/or regulatory agencies through the blockchain.

FIG. 3 includes an illustrative example of the functionality of the secure transaction application 104 according to an exemplary embodiment of the present disclosure. As shown, various stakeholders 302a-302g and regulatory agencies 302h, 302i may be involved in the supply chain process. As an example, an importer/broker 302g may complete various transactions 304a-304c that may be completed for each shipment of goods that may be imported. The importer/broker 302g may additionally be involved in duty programs 304e that may be associated with a trade account 306 that includes an account subsidiary ledger that may link trade attributes together such as HTS, COO, MID, COE, MOT, and SPGI identified from the importer's entry history or planned shipments. In one configuration, the transaction data reception module 202 of the secure transaction application 104 may be configured to receive the trade account data as a plurality of transaction data points associated with each shipment and may store the plurality of transaction data points within the supply chain data repository 110 for a predetermined period of time.

In one or more embodiments, the transaction data categorization module 204 of the secure transaction application 104 may be configured to access the plurality of transaction data points and may categorize each of the plurality of transaction data points. For example, information included within each of the plurality of transaction data points may be classified in categories associated with the various transactions 304a-304c. The transaction data aggregation module 206 of the secure transaction application 104 may be further configured to aggregate the plurality of transaction data points associated with one or more of the categories. The transaction data aggregation module 206 may thereby package the aggregated data points into one or more transactional data packages that may be associated with one or more of the transactions 304a-304c.

Upon aggregating the plurality of transaction data points, the transaction execution module 208 of the secure transaction application 104 may be configured to pass the one or more transactional data packages through the blockchain infrastructure 112 to be communicated to one or more additional stakeholders 302a-302f. In some embodiments, the application 104 may allow one or more of the stakeholders 302a-302f to adjust transactions through one or more HMIs of the application 104 and/or customized user interfaces that are utilized by third-party applications used by one or more stakeholders and/or regulatory agencies. For example, the importer/broker 302g may adjust transactions using the HMIs of the application 104. The application 104 may be configured to present the transactional data points as individually presented through an HMI of the application 104. The application 104 may also allow one or more of the stakeholders 302a-302f to adjust information included within the transactional data points. Such adjusted information may be output as an amended transaction 304d that may be passed through the blockchain infrastructure 112.

In some configurations, the transaction execution module 208 of the secure transaction application 104 may be configured to pass the one or more transactional data packages through the blockchain infrastructure 112 to be communicated to one or more regulatory agencies through a respective transaction portal 118. As shown in the illustrative example of FIG. 3, in one example the regulatory agency Customs and Border Protection (CBP) 302i may include a customized transaction portal 118 that may be configured in the form of a CBP node 310 that may specifically include data entry points associated with computing systems, applications, and application interfaces utilized by the CBP 302i. Accordingly, the secure transaction application 104 may reduce an amount of overhead related to communication of multiple transactions between the stakeholders 302a-302g and/or regulatory agencies 302h, 302i within a supply chain process.

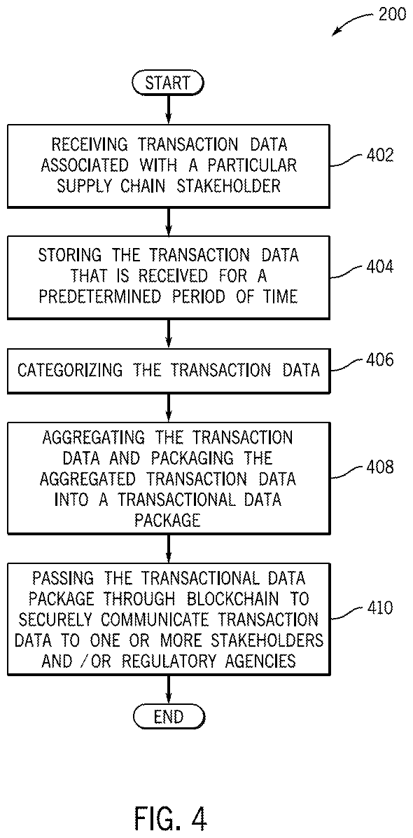

FIG. 4 is a process flow diagram of a method 400 for aggregating and communicating supply chain transaction data to one or more stakeholders according to an exemplary embodiment of the present disclosure. FIG. 4 will be described with reference to the components of FIG. 1 and FIG. 2 through it is to be appreciated that the method 400 of FIG. 4 may be used with additional and/or alternative system components. The method 400 may begin at block 402, wherein the method 400 may include receiving transaction data associated with a particular supply chain stakeholder.

In an exemplary embodiment, the transaction data reception module 202 of the secure transaction application 104 may be configured to utilize the communication unit 114 to present HMIs of the application 104 through the supply chain computing infrastructure 116 to one or more stakeholders and/or regulatory agencies. The HMIs may include various user interfaces that may be presented to various supply chain stakeholders and/or regulatory agencies. The various user interfaces may be customized with specific user interface inputs, user interface input icons, user interface input fields, user interface graphics, and the like that may specifically apply to each of the supply chain stakeholders and/or regulatory agencies. Accordingly, the user interfaces may enable each of the stakeholders and/or regulatory agencies to input and/or adjust one or more transactions that may be presented in one or more formats that may specifically apply to the stakeholders and/or regulatory agencies.

In one or more configurations, the HMI may be pre-populated with certain pre-stored data that may be associated with the specific stakeholder (e.g., stakeholder ID, location, stakeholder type (e.g., OEM, carrier, shipper) financial account data, statements, general ledger of accounts, etc.), regulatory agency information (e.g., regulatory agency name, regulatory agency codes). The HMI may additionally be automatically populated based on the scanning of one or more products/shipments with specific data associated with the products (e.g., product name, product ID, product model), and specific data associated with the transaction itself (e.g., transaction ID) that may be assigned by the respective stakeholders and/or respective regulatory agencies. Accordingly, upon the input of transaction data by one or more of the stakeholders and/or regulatory agencies through the HMI, the transaction data reception module 202 may be configured to receive the transaction data through the communication unit 114 of the logistics server 102.

The method 400 may proceed to block 404, wherein the method 400 may include storing the transaction data that is received for a predetermined period of time. In an exemplary embodiment, upon receiving the transaction data, the transaction data reception module 202 may be configured to access the supply chain data repository 110 stored on the memory 108 of the logistics server 102. Upon accessing the supply chain data repository 110, the transaction data reception module 202 may be configured to store the transaction data as a plurality transaction data points upon the supply chain data repository 110.

The transaction data may be stored within respective records of the supply chain data repository 110 that is specifically associated with the particular stakeholder(s) and/or types of information included within the transaction data. In one embodiment, the transaction data reception module 202 may be configured to store the plurality of transaction data points upon the respective records of the supply chain data repository 110 for a predetermined period of time. For example, the transaction data reception module 202 may be configured to store the transaction data in the form of the plurality of transaction data points that are received during a predetermined period of time of thirty-days within the record(s) associated with the respective stakeholder(s).

The method 400 may proceed to block 406, wherein the method 400 may include categorizing the transaction data. In an exemplary embodiment, upon storing the plurality of transaction data points upon the respective records of the supply chain data repository 110, the transaction data reception module 202 may be configured to communicate data pertaining to the storage of transaction data to the transaction data categorization module 204 of the secure transaction application 104. In one or more embodiments, the transaction data categorization module 204 may be configured to access the supply chain data repository 110 and may analyze the plurality of transaction data points of the one or more types of transaction data that have been inputted by one or more stakeholders and/or regulatory agencies.

In one embodiment, the transaction data categorization module 204 may analyze the transaction data points to categorize the transaction data into one or more data categories that may be associated with regulatory information, legal information, contractual information, transactional information, customs information, trade account information, and/or product specific information included within the transaction data. In one or more configurations such categories may be based on the type of transaction data that is included within the transaction data points. As discussed above, such types of data may include, but may not be limited to, financial transactional data, accounting data, financial account data, specific data associated with one or more goods/products (e.g., product name, product ID, product model), accounting data that may be associated with one or more specific accounts, contractual data associated with one or more contracts that may pertain to one or more particular stakeholders and/or regulatory agencies, statistical data, payment status data, trade account classifications and data associated with one or more trade accounts that may link trade attributes together, and specific identification data associated with the each supply chain transaction itself (e.g., transaction ID). Accordingly, the transaction data categorization module 204 may analyze the one or more types of transaction data to determine and categorize the type of information included within the one or more types of transaction data. Such categorizations may be appended to the one or more transactional data points that are stored upon the supply chain data repository 110.

The method 400 may proceed to block 408, wherein the method 400 may include aggregating the transaction data and packaging the aggregated transaction data into a transactional data package. In an exemplary embodiment, the transaction data aggregation module 206 of the secure transaction application 104 of the secure transaction application 104 may be configured to access the supply chain data repository 110 and retrieve the plurality of transaction data points that may be associated with the respective stakeholder(s) previously stored for the predetermined period of time. Upon accessing the plurality of transaction data points, the secure transaction application 104 may be configured to analyze the transaction data points and may aggregate the transaction data points.

In one embodiment, the transaction data aggregation module 206 may combine data included within the transaction data points that are specifically associated with one or more particular stakeholders and/or regulatory agencies. The transaction data aggregation module 206 may specifically organize transaction specific data by trade accounts such as data associated with each specific transaction, accounting cycle data, and/or linked chart of trade accounts to be presented as unitary transaction data. Upon aggregating the transaction data points, the secure transaction application 104 may be configured to electronically package the aggregated data into a transactional data package (e.g., data packet).

In some embodiments, the transaction data aggregation module 206 may analyze the transaction data points that may be associated with one or more particular stakeholders to determine the categorization of transaction data points as appended to the transaction data points stored upon the supply chain data repository 110 (as discussed with respect to block 406). The transaction data aggregation module 206 may thereby aggregate two or more transaction data points that may be categorized in one or more particular categories. Accordingly, the data pertaining to one or more particular categories may be aggregated into transactional data packages that are include specific types of transaction data that may be communicated to one or more stakeholders and/or regulatory agencies based on requirements.

The method 400 may proceed to block 410, wherein the method 400 may include passing one or more transaction data packages through blockchain to securely communicate transaction data to one or more stakeholders and/or regulatory agencies. In an exemplary embodiment, upon aggregating the transaction data and packaging the aggregated data into one or more transactional data packages, the transaction data aggregation module 206 may be configured to communicate the aggregation of the transaction data into the one or more transactional data packages to the transaction execution module 208 of the secure transaction application 104.

In an exemplary embodiment, the transaction execution module 208 may be configured to utilize the communication unit 114 to access the blockchain infrastructure 112. Upon accessing the blockchain infrastructure 112, the transaction execution module 208 may be configured to pass the one or more transactional data packages through the blockchain. Accordingly, the one or more transactional data packages associated with one or more supply chain stakeholders and/or one or more regulatory agencies may be verified through blockchain technologies to complete the secure communication of transaction data to one or more additional stakeholders and/or one or more regulatory agencies.

Stated differently, the transaction execution module 208 may ensure that numerous individual transactions that are to be communicated between stakeholders and/or regulatory agencies within the supply chain are reduced and securely communicated through the blockchain to one or more additional stakeholders and/or regulatory agencies through the transaction portal 118. The secure transaction application 104 may accordingly apply the use of the aggregation of transaction data associated with a plurality of supply chain transactions and the use of blockchain to supply chain, logistics, and trade related transactions to provide a framework for achieving a more time efficient, cost efficient, and work flow efficient information flow between one or more stakeholders and/or one or more regulatory agencies involved within the supply chain.

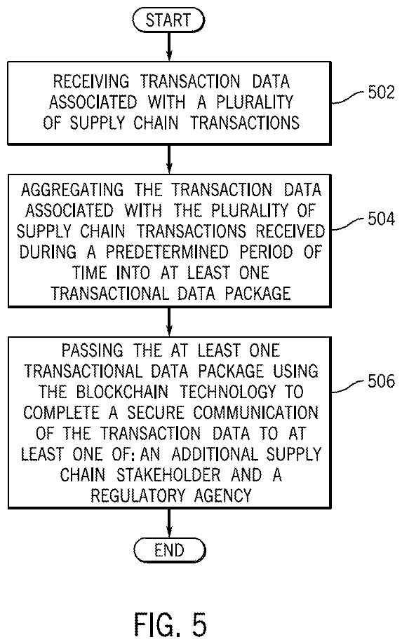

FIG. 5 is a process flow diagram of a method 500 for providing an automated trade transaction using blockchain technology according to an exemplary embodiment of the present disclosure. FIG. 5 will be described with reference to the components of FIG. 1 and FIG. 2 through it is to be appreciated that the method 500 of FIG. 5 may be used with additional and/or alternative system components. The method 500 may begin at block 502, wherein the method 500 may include receiving transaction data associated with a plurality of supply chain transactions. In one embodiment, the plurality of supply chain transactions are associated with a supply chain stakeholder.

The method 500 may proceed to block 504, wherein the method 500 may include aggregating the transaction data associated with the plurality of supply chain transactions received during a predetermined period of time into at least one transactional data package. The method 500 may proceed to block 506, wherein the method 500 may include passing the at least one transactional data package using the blockchain technology to complete a secure communication of the transaction data to at least one of: an additional supply chain stakeholder and a regulatory agency.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

1. A computer-implemented method for providing an automated trade transaction using blockchain technology comprising:
electronically receiving transaction data associated with a plurality of supply chain transactions, wherein the plurality of supply chain transactions are associated with a supply chain stakeholder;
electronically aggregating the transaction data associated with the plurality of supply chain transactions received during a predetermined period of time into at least one transactional data package;
electronically providing and assigning secure encrypted credentials to the supply chain stakeholder and at least one of: an additional supply chain stakeholder and a regulatory agency to securely access a blockchain infrastructure; and
electronically passing the at least one transactional data package through the blockchain infrastructure to complete a secure communication of the transaction data between the supply chain stakeholder and at least one of: the additional supply chain stakeholder and the regulatory agency.

2. The computer-implemented method of claim 1, wherein electronically receiving the transaction data includes receiving a plurality of transaction data points that are associated with the plurality of supply chain transactions, wherein the plurality of transaction data points are electronically stored upon a supply chain data repository for the predetermined period of time.

3. The computer-implemented method of claim 2, further including electronically analyzing the transaction data and electronically categorizing the transaction data into at least one data category that is associated with at least one of: regulatory information, legal information, contractual information, transactional information, customs information, trade account information, and product specific information included within the transaction data, wherein the at least one data category is appended to the plurality of transaction data points that are stored upon the supply chain data repository.

4. The computer-implemented method of claim 2, wherein electronically aggregating the transaction data includes accessing the supply chain data repository and retrieving the plurality of transaction data points, wherein the plurality of transaction data points are aggregated into unitary transaction data that pertains to the predetermined period of time.

5. The computer-implemented method of claim 4, wherein the electronically aggregated transaction data is packaged into the at least one transactional data package that includes transaction data associated with the plurality of supply chain transactions received during the predetermined period of time.

6. The computer-implemented method of claim 5, wherein electronically providing and assigning secure encrypted credentials includes providing the secure encrypted credentials as private encrypted data keys that are respectively assigned to the supply chain stakeholder and at least one of: the additional supply chain stakeholder and the regulatory agency.

7. The computer-implemented method of claim 6, wherein each of the private encrypted data keys are publicly inaccessible and are encrypted with at least one of: a numerical encrypted key code and an alpha-numerical encrypted key code.

8. The computer-implemented method of claim 7, wherein each of the private encrypted data keys are exchanged as ownership credentials to securely access the blockchain infrastructure through a transaction portal to communicate the transactional data package from the blockchain infrastructure to the transaction portal.

9. The computer-implemented method of claim 8, wherein the transaction portal is at least one node that allows the secure communication of the transaction data between the supply chain stakeholder and at least one of: the additional supply chain stakeholder and the regulatory agency upon the exchange of the private encrypted data keys.

10. A system for providing an automated trade transaction using blockchain technology comprising:
a memory storing instructions when executed by a processor cause the processor to:
electronically receive transaction data associated with a plurality of supply chain transactions, wherein the plurality of supply chain transactions are associated with a supply chain stakeholder;
electronically aggregate the transaction data associated with the plurality of supply chain transactions received during a predetermined period of time into at least one transactional data package;
electronically provide and assigning secure encrypted credentials to the supply chain stakeholder and at least one of: an additional supply chain stakeholder and a regulatory agency to securely access a blockchain infrastructure; and
electronically pass the at least one transactional data package through the blockchain infrastructure to complete a secure communication of the transaction data between the supply chain stakeholder and at least one of: the additional supply chain stakeholder and the regulatory agency.

11. The system of claim 10, wherein electronically receiving the transaction data includes receiving a plurality of transaction data points that are associated with the plurality of supply chain transactions, wherein the plurality of transaction data points are electronically stored upon a supply chain data repository for the predetermined period of time.

12. The system of claim 11, further including electronically analyzing the transaction data and electronically categorizing the transaction data into at least one data category that is associated with at least one of: regulatory information, legal information, contractual information, transactional information, customs information, trade account information, and product specific information included within the transaction data, wherein the at least one data category is appended to the plurality of transaction data points that are stored upon the supply chain data repository.

13. The system of claim 11, wherein electronically aggregating the transaction data includes accessing the supply chain data repository and retrieving the plurality of transaction data points, wherein the plurality of transaction data points are aggregated into unitary transaction data that pertains to the predetermined period of time.

14. The system of claim 13, wherein the electronically aggregated transaction data is packaged into the at least one transactional data package that includes transaction data associated with the plurality of supply chain transactions received during the predetermined period of time.

15. The system of claim 14, wherein electronically providing and assigning secure encrypted credentials includes providing the secure encrypted credentials as private encrypted data keys that are respectively assigned to the supply chain stakeholder and at least one of: the additional supply chain stakeholder and the regulatory agency.

16. The system of claim 15, wherein each of the private encrypted data keys are publicly inaccessible and are encrypted with at least one of: a numerical encrypted key code and an alpha-numerical encrypted key code.

17. The system of claim 16, wherein each of the private encrypted data keys are exchanged as ownership credentials to securely access the blockchain infrastructure through a transaction portal to communicate the transactional data package from the blockchain infrastructure to the transaction portal.

18. The system of claim 17, wherein the transaction portal is at least one node that allows the secure communication of the transaction data between the supply chain stakeholder and at least one of: the additional supply chain stakeholder and the regulatory agency upon the exchange of the private encrypted data keys.

19. A non-transitory computer readable storage medium storing instructions that when executed by a computer, which includes a processor perform a method, the method comprising:
electronically receiving transaction data associated with a plurality of supply chain transactions, wherein the plurality of supply chain transactions are associated with a supply chain stakeholder;
electronically aggregating the transaction data associated with the plurality of supply chain transactions received during a predetermined period of time into at least one transactional data package;
electronically providing and assigning secure encrypted credentials to the supply chain stakeholder and at least one of: an additional supply chain stakeholder and a regulatory agency to securely access a blockchain infrastructure; and
electronically passing the at least one transactional data package through the blockchain infrastructure to complete a secure communication of the transaction data between the supply chain stakeholder and at least one of: the additional supply chain stakeholder and the regulatory agency.

20. The non-transitory computer readable storage medium of claim 19, wherein electronically providing and assigning secure encrypted credentials includes providing the secure encrypted credentials as private encrypted data keys that are respectively assigned to the supply chain stakeholder and at least one of: the additional supply chain stakeholder and the regulatory agency.
